(19) United States
(12) Patent Application Publication
(10) Pub. No.: US 2006/0268106 A1
(43) Pub. Date: Nov. 30, 2006

(54) Optical display screen device

(76) Inventors: Terence Alfred Cooper, Newark, DE (US); Kenji Yoshida, Tokyo (JP)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/434,285

(22) Filed: May 15, 2006

Related U.S. Application Data
(63) Continuation-in-part of application No. 10/882,989, filed on Jun. 30, 2004, now abandoned.

(51) Int. Cl. H04N 7/18

(52) U.S. Cl. 348/126

(57) ABSTRACT

A display screen is provided having both a diffusion layer and an absorption layer. The screen may be formed by coextrusion and may be suitable for use in rear projection applications.

### CROSS-REFERENCE TO RELATED APPLICATIONS

This application is a continuation-in-part of co-pending U.S. patent application Ser. No. 10/882,989, filed on Jun. 30, 2004, the entire disclosure of which is incorporated by reference herein.

### BACKGROUND

The present disclosure is directed to display screens which are formed by co-extrusion of the layers utilized to form the screens. Such screens may be suitable for large formats, including use in rear projection television systems, rear projection display screen systems for simulation rooms, control rooms, large advertising displays, information displays, and the like.

Recent advances in projection television, interactive whiteboards, digital signage and other display technologies have led to the need for the development of increasingly large display screens in both the transmission and reflection modes. High performance rear projection screens require balanced characteristics of resolution, gain, contrast, and wide viewing angle. The screen must provide sufficient resolution to display sharp images for both video and data presentation and must, at the same time, cause diffusion of the light in such a way as to provide a wide viewing audience angle while still providing high brightness and high contrast, particularly for viewing in the presence of ambient light. A gray or black tint is generally incorporated in monolayer diffusion screens to provide this required contrast.

However, there is still a need for the development of improved, inexpensive and efficient front- and rear-projection screens with desirable combinations of the above light-scattering and transmission properties. This need is now addressed by the multilayer optical device of the present disclosure.

Monolayer diffuser sheets which include a matrix polymer, often based on polymethyl methacrylate or polycarbonate polymers, and containing a dispersion of light scattering centers with a controlled refractive index differential between the matrix and the light-scattering centers are known in the art. For example, U.S. Pat. No. 4,165,153 discloses a translucent screen having a dispersion of particles with a low index of refraction, such as polytetrafluoroethylene or vinylidene fluoride/tetrafluoroethylene copolymers, in a continuous polymeric matrix with a higher index of refraction such as poly (ethylene/maleic anhydride) and its half esters, polyvinyl butyral or polymethyl cellulose. The polymeric matrix can also incorporate a small amount of a light absorbing material such as carbon black to provide contrast. As a further example, U.S. Pat. Nos. 5,237,004 and 5,346,954 disclose light diffusing polymer compositions including a matrix polymer such as polymethyl methacrylate in which is distributed substantially spherical core-shell particles, with an average diameter ranging from about 2 microns to 15 microns, which contain a core of a rubbery alkyl acrylate polymer or copolymer with an alkyl methacrylate or styrenic monomer and one or more outer shells wherein the outermost shell is compatible with the matrix polymer. The core-shell particles are specified to have a refractive index within about 0.05 units but no closer than about 0.003 units relative to the refractive index of the matrix polymer. Similarly, U.S. patent application No. 2004006645 discloses a bulk diffuser material comprising a polycarbonate matrix with scattering centers comprising polyacrylates, polyalkylmethacrylates, polytetrafluoroethylene, silicones, various inorganic materials and mixtures thereof. However, these monolayer bulk diffusers as described in the art do not simultaneously provide an optimum combination of brightness, angle of view, contrast and resolution for use in large display screens such as for projection television, interactive whiteboards, and digital signage.

Bilayer optical devices are also known in the art. For example, U.S. Pat. Nos. 2,180,113 and 2,287,556 describe translucent screens composed of one transparent polymeric layer and second layer composed of discrete particles as a discontinuous phase dispersed throughout a continuous layer of the same material as the first layer, such as particles of polybenzylcellulose dispersed in polyethylcellulose. As a further example, U.S. Pat. No. 5,307,205 discloses a bilayer sheet constructed of a supporting clear polymeric, preferably thermoplastic, layer such as polymethyl methacrylate, and a second polymeric layer, preferably composed of a thermoplastic such as polymethyl methacrylate and preferably also tinted, containing specific, substantially spherical, light diffusing particles. These particles are composed of rubbery alkyl acrylate polymers, such as polybutyl acrylate, or copolymers such as alkyl acrylate/styrene copolymers or else are core-shell particles where the rubbery alkyl acrylate polymer or copolymer is surrounded by one or more shells wherein the outermost shell is compatible with the matrix polymer. Such bilayer optical devices are claimed to provide a good balance of wide viewing angle, resolution, gain and contrast when used for rear projection screens. However, one issue with devices of this type, similar to monolayer and tinted monolayer devices, is that in order to obtain a wide viewing angle, either the concentration of the diffuser particles or the thickness of the tinted diffuser sheet must be increased, which leads to a decreased resolution and lower gain (brightness). Furthermore, in order to obtain high contrast, the concentration of the tint component must be increased with a resulting decrease in gain and brightness. In addition, for devices of this type and in monolayer devices, incorporation of the contrast tint medium in the same matrix as the diffuser particles also reduces the blackness of the screen device under ambient light and the presence of multiple scattering pathways in the diffuser layer causes a whitening effect which decreases the effectiveness of the tint agent, thereby requiring an even higher concentration of this agent and resulting in reduced brightness.

### SUMMARY

The present disclosure provides display screens suitable for optical display devices. In embodiments, the present disclosure provides devices including at least one diffusion layer including a thermoplastic resin in combination with scattering particles, the diffusion layer having a thickness from about 0.45 mm to about 4 mm, and at least one absorption layer including a thermoplastic resin in combination with at least one colorant, the absorption layer having a thickness from about 0.1 mm to about 2 mm, wherein the diffusion layer is coextensive with the absorption layer.

In embodiments, a device of the present disclosure may include at least one diffusion layer including a methyl methacrylate copolymer in combination with core-shell scattering particles having an average diameter from about 2 microns to 15 microns, the diffusion layer having a thickness from about 0.45 mm to about 4 mm, and at least one absorption layer including a methyl methacrylate copolymer in combination with a polymer soluble black anthraquinone dye, the absorption layer having a thickness from about 0.1 mm to about 2 mm, wherein the diffusion layer is coextensive with the absorption layer.

Display screens of the present disclosure may be utilized in various optical display devices. In embodiments, the present disclosure provides a rear projection television system including a projector, a mirror, a fresnel lens, a lenticular lens, and a device of the present disclosure including at least one diffusion layer including a thermoplastic resin in combination with scattering particles, the diffusion layer having a thickness from about 0.45 mm to about 4 mm, and at least one absorption layer including a thermoplastic resin in combination with at least one colorant, the absorption layer having a thickness from about 0.1 mm to about 2 mm, wherein the diffusion layer is coextensive with the absorption layer, and wherein the components of the projection television system are housed in a cabinet with the device of the present disclosure forming the display screen on which images are viewed.

In embodiments, a display screen of the present disclosure may also include at least one diffusion layer including a thermoplastic resin in combination with scattering particles, the diffusion layer having a thickness from about 0.45 mm to about 4 mm, an optional absorption layer including a thermoplastic resin in combination with at least one colorant, the absorption layer having a thickness from about 0.1 mm to about 2 mm, and a reflective layer applied to the at least one diffusion layer, wherein the diffusion layer is coextensive with the absorption layer and the reflective layer permits both partial reflection and partial transmission of light, thereby permitting images to be visualized by both reflection and transmission.

Methods for forming a display screens of the present disclosure are also provided which include contacting a thermoplastic resin with scattering particles to form a diffusion layer precursor, contacting a thermoplastic resin with a colorant to form an absorption layer precursor, and co-extruding the diffusion layer precursor and the absorption layer precursor to form a display screen having a diffusion layer and an absorption layer, wherein the diffusion layer has a thickness from about 0.45 mm to about 4 mm, the absorption layer has a thickness from about 0.1 mm to about 2 mm, and the diffusion layer is coextensive with the absorption layer.

### BRIEF DESCRIPTION OF THE FIGURES

FIG. 1 is a depiction of a prior art rear projection system;

FIG. 2 is a depiction of an embodiment of a prior art projection television system;

FIG. 3 is a depiction of a rear projection system utilizing a multilayer display screen of the present disclosure; and

FIG. 4 is a depiction of a rear projection television system utilizing a multilayer display screen of the present disclosure.

### DETAILED DESCRIPTION

In accordance with the present disclosure, display screens for use with, or incorporated in, optical display devices are provided which may be formed by co-extrusion of the layers utilized to form the screens. Such screens are suitable for large formats, including use in rear projection television systems, rear projection display screen systems for simulation rooms, control rooms, large advertising displays, information displays, and the like.

In accordance with the present disclosure, the display screens include both a diffusion layer and a separate absorption layer. In embodiments, the diffusion layer and absorption layer may be co-extruded to form a display screen of the present disclosure. Surprisingly, it has been found that by separating the contrast tint or colorant in the absorption layer from the scattering particles in the diffusion layer, the viewing angle and resolution can be separately controlled from the brightness and contrast, leading to the production of markedly improved display screens systems suitable for large projection television and other large screen applications.

At least one layer of the device of the present disclosure is a diffusion layer which includes a polymeric matrix material, in embodiments an amorphous thermoplastic resin, containing throughout its bulk scattering particles which provide the desired light scattering or diffusion properties.

Suitable amorphous thermoplastic resins should have a heat distortion temperature of at least about 70° C., in embodiments at least about 80° C., typically at least about 100° C., as measured at 66 psi according to the method of ASTM D648. Suitable thermoplastic resins typically have high clarity and include, for example, alkyl acrylates and polyalkyl and aralkyl methacrylate polymers such as polymethyl methacrylate, methacrylate copolymers, styrenic polymers such as polystyrene, polyalkylstyrenes and styrenic copolymers such as styrene-acrylonitrile copolymers and styrene-methyl methacrylate copolymers, olefin-vinyl acetate copolymers, cyclic polyolefins, polymethylpentene, polyolefins such as polyethylene and polypropylene and their copolymers, polyetherimides, polyetherimide sulfones, polysulfones, polyethersulfones, polyphenylene ether sulfones, poly(arylene ether)s, polyglutarimide, polycarbonates, polyester carbonates, polyarylates, and the like, and combinations thereof.

Where necessary to provide impact resistance, toughened transparent materials may be used such as transparent polymethyl methacrylate or methacrylate copolymers which are impact-modified by the incorporation of core-shell impact modifier particles in the methacrylate polymer matrix. Such core-shell modifier particles may possess an inner shell of an alkyl acrylate rubber and a grafted outer shell largely containing polymethyl methacrylate, or an inner core of polymethyl methacrylate chemically grafted to an intermediate layer of an alkyl acrylate rubber and a grafted outer shell largely containing polymethyl methacrylate. In embodiments, the refractive index may be matched to the matrix methacrylate polymer and the impact modifier particle size may be less than about 500 nm to provide a clear toughened material. In other embodiments, inherently tough materials such as polycarbonates may also be employed. These thermoplastics and methods for their preparation are within the purview of those skilled in the art.

The polymeric matrices utilized to form the diffusion layer may have a refractive index of from about 1.45 to about 1.66, in embodiments from about 1.49 to about 1.59.

The scattering particles in the diffusion layer should be particles with excellent light transmittance and light diffusion properties. Such particles can be preformed particulate structures, including thermoplastic or thermoset resin particles such as alkyl (meth)acrylate-type resins, styrene-type resins, vinyl carboxylate resins and polysiloxane-type resins, and homopolymers, copolymers and combinations thereof. In embodiments, the scattering particles may be crosslinked materials and/or multi-staged polymeric materials such as core-shell particles with appropriate particle size and refractive index properties.

Other examples of suitable scattering particles include immiscible mineral, glass or ceramic particles, for example inorganic oxides such as silica, alumina, titanium dioxide, antimony oxide, zirconia, and tungsten oxide, silicate-based and aluminosilicate-based minerals, and inorganic carbonates.

Particles utilized as the light scattering element in the diffusion layer may vary in size from about 0.4 microns to about 20 microns in diameter, in embodiments from about 1 micron to about 15 microns in diameter.

The volume fraction or volume concentration of the scattering particles dispersed in the bulk of the polymeric matrix of the diffusion layer may be from about 0.2% to about 40% by volume, depending on the optical properties required, the refractive index differential between the matrix material and scattering particles, and the desired thickness of the diffusion layer. In some embodiments, the fraction of scattering particles in the polymeric matrix may vary from about 0.5% to about 30% by volume, in other embodiments from about 8% to about 20% by volume. The scattering particles form a stable dispersion in the bulk of the polymeric matrix material i.e., the particles do not substantially aggregate or agglomerate during the processing and production of the diffusion layer, nor do they concentrate at the surfaces or interfaces with other layer, but are dispersed throughout the bulk of the diffusion layer.

Whichever types of particles are selected, they should have a combination of optical properties (particularly refractive index), particle size, particle size distribution, particle shape, and concentration in the polymeric matrix which provides the desired scattering properties, resolution and brightness properties. The optimum bulk concentration will depend on the scattering properties required, the refractive index differential between the diffuser particles and the matrix, and the desired thickness of the diffuser layer.

The mode of light scattering or diffusion in a display screen of the present disclosure is bulk or volumetric light scattering which occurs throughout the bulk or total volume of the diffusion layer. This is quite different from the surface scattering encountered in some other optical screen devices or anti-glare or anti-reflection layers, where the scattering is produced by particles or beads coated on or embedded in the surface of the device or layer or by surface roughness produced by such methods as embossing, molding of an irregular surface, or mechanical surface roughening. Thus, the diffusion layer of a display screen of the present disclosure scatters transmitted light in a controlled fashion over a wide angle and, as it is a bulk or volumetric scattering system, it may produce cascading scattering, i.e., light initially entering the diffusion layer that becomes scattered upon contact with a light scattering particle may become further scattered as it passes through the diffusion layer as it contacts additional light scattering particles. Thus, the greater the thickness of the diffusion layer, the greater the scattering produced, which is in contrast to scattering obtained by surface scattering methods described above. The diffusion layer may have a thickness from about 0.45 mm to about 4 mm, in embodiments from about 0.5 mm to about 3 mm.

Display screens of the present disclosure possess high transmission gain (or brightness) with high contrast, high resolution and a wide viewing angle. This wide viewing angle is measured in terms of a high light-scattering half-angle, i.e. the angle from the normal angle to the surface at which the light intensity is half that at the normal angle. The scattering half-angle of projected light through a display screen of the present disclosure may be from about 5° to about 50°, in embodiments from about 10° to about 40°.

The diffusion layer or layers may possess one or more types of polymeric matrixes in one or more diffusion layers, and the degree and type of scattering in the diffusion layers may be controlled by the composition, thickness and method of processing of the resins utilized to form these diffusion layers.

The refractive index differential between the scattering particles and the transparent matrix utilized to form the diffusion layer, as well as the particle size distribution and volume fraction and layer thickness, may be optimized to provide the desired combination of viewing cone and other optical properties such as resolution and transmission (gain) necessary for a specific application. In embodiments, the polymeric matrix material of the diffusion layer and the scattering particles dispersed in the polymeric matrix of the diffusion layer have a difference in refractive index from about 0.003 units to about 0.16 units, in embodiments from about 0.008 units to about 0.14 units.

At least one other layer of a display screen of the present disclosure is a light absorption layer which includes a polymeric matrix material, in embodiments an amorphous thermoplastic resin, containing one or more light absorbers. The light absorber(s) may control, as desired, the light transmission through the layer and the frequency, color and contrast properties of the display screen and any device possessing such a display screen.

Suitable thermoplastic resins which may be utilized as the polymeric matrix in forming the absorption layer may have a heat distortion temperature of at least about 70° C., in embodiments at least about 80° C., typically at least about 100° C., as measured at 66 psi according to ASTM D648. Suitable thermoplastic resins possess high clarity and include, for example, polyalkyl and aralkyl methacrylate polymers, such as polymethyl methacrylate and methacrylate copolymers, styrenic polymers such as polystyrene, polyalkylstyrenes and styrenic copolymers such as styrene-acrylonitrile copolymers and styrene-methyl methacrylate copolymers, olefin-vinyl acetate copolymers, cyclic polyolefins, polymethylpentene polymers, polyolefins such as polyethylene and polypropylene, polyetherimides, polyetherimide sulfones, polysulfones, polyethersulfones, polyphenylene ether sulfones, poly(arylene ether)s, polyglutarimide, polycarbonates, polyester carbonates and the like, and combinations thereof.

Where necessary to provide impact resistance, toughened transparent materials may be used such as transparent polymethyl methacrylate or methacrylate copolymers which are impact-modified by the incorporation of core-shell impact modifier particles in the methacrylate polymer matrix. Such core-shell modifier particles may possess an inner shell of an alkyl acrylate rubber and a grafted outer shell largely containing polymethyl methacrylate, or an inner core of polymethyl methacrylate chemically grafted to an intermediate layer of an alkyl acrylate rubber and a grafted outer shell largely containing polymethyl methacrylate. In embodiments, the refractive index may be matched to the matrix methacrylate polymer and the impact modifier particle size may be less than about 500 nm to provide a clear toughened material. In other embodiments, inherently tough materials such as polycarbonates may also be employed. These thermoplastics and methods for their preparation are within the purview of those skilled in the art.

The polymeric matrices utilized to form the absorption layer may have a refractive index of from about 1.45 to about 1.66, in embodiments from about 1.49 to about 1.59.

Suitable absorbers which may be utilized in the absorption layer to absorb light include, for example, color and contrast agents which can be soluble or insoluble colored or black dyes or pigments, or combinations of such dyes or pigments. Such dyes and pigments should be selected such that they have the requisite photostability for use over the lifetime of a projection screen and do not give rise to adverse effects on the light stability, thermal or physical properties of the matrix polymer system utilized to form the absorption layer.

The terms dyes and pigments are used herein to describe colorants with differing solubilities in the polymeric matrix utilized to form the absorption layer. As used herein, dyes include, for example, those colorants which are essentially soluble in the polymer matrix utilized to form the absorption layer. Pigments, as used herein, include, for example, those colorants which are essentially insoluble in the polymer matrix utilized to form the absorption layer.

Dyes may advantageously be used to minimize haze, maximize transmission, and minimize deterioration of the physical properties of the polymeric matrix utilized to form the absorption layer of a display screen of the present disclosure. In embodiments, suitable dyes which may be utilized include black dyes such as azo dyes, anthraquinone dyes, amino dyes, phthalocyanines, triarylmethane dyes, and azine dyes such as indulines and nigrosines. In other embodiments, combinations of additive primary colors, such as blue, red and green dyes, can be utilized to produce a colorant having absorption properties similar to black dyes, which may be useful in the absorption layer of a display screen of the present disclosure. Suitable colored dyes include, but are not limited to, azo dyes, anthraquinone dyes, phthalocyanines, perinone dyes, carotenoid dyes, polymethine dyes, and quinoline dyes. In some embodiments it may be desirable to utilize colors other than black as dyes in the absorption layer to achieve desired light absorption effects. Such colors can be obtained by selection of the appropriate dyes or combinations of dyes.

Specific examples of suitable black dyes which may be used in the absorption layer include, for example, light-fast anthraquinone dyes such as LambdaPlast Solvent Black LN from Buckeye Color and azine dyes such as Nigrosine CI Solvent Black 5 and CI Acid Black 2. In other embodiments, azo dyes such as CI Solvent Black 13 and Direct Black SP (Noir Cellusol SP) and sulfur black dyes such as CI Sulfur Black 1 can also be used.

In other embodiments, pigments may be utilized as light absorbers in forming an absorption layer of the present disclosure. As noted above, while dyes may be soluble in the polymeric matrix utilized to form a light absorption layer, pigments may be insoluble in the polymeric matrix. Suitable pigments which may be utilized include both inorganic and/or organic pigments. Suitable inorganic pigments include, but are not limited to, carbon black, black iron oxide, copper chromite and titanium black. Suitable organic pigments include, but are not limited to, polymer-insoluble anthraquinone derivatives such as anthraquinone vat dyes, azo-compounds, perylene pigments and sulfur-based compounds.

In other embodiments, pigments can include azo vat dyes which, while soluble in water, are generally insoluble in the polymer matrix utilized to form an absorption layer. Such azo vat dyes include, but are not limited to, CI Acid Black 1, CI Direct Black 19 and CI Food Black 2, polycyclic aromatic carbonyl (anthraquinone) dyes such as CI Vat Black 8, 27, 25 and 28, and phthalocyanine-precursor dyes such as Phthalogen Black IVM. In some embodiments, a black pigment such as carbon black, typically channel black or lampblack, may be utilized as a pigment in the absorption layer. Such pigments, even though insoluble, are stable in the polymer utilized to form the absorption layer, are relatively inexpensive, and produce absorption layers possessing the desired light absorption characteristics.

Such black dyes, or combination of dyes to give the effect of a black dye, or black pigments, may be selected so as to cause absorption of light radiation over the visible light range at wavelengths of from about 400 nm to about 750 nm. In embodiments, this absorption of light may substantially block all of these wavelengths to the extent desired for the specific application and provide a desired percentage light transmission and attenuation for the specific application.

The nature and properties of the above-described dyes and pigments, together with methods for making them, are discussed, for example, in Kirk-Othmer Encyclopedia of Chemical Technology, 4^{th} Edition 1993, Vol. 6 p. 944-965 and Vol. 8 p. 602-671, in K. Venkataraman, “The Chemistry of Synthetic Dyes”, Academic Press 1952-1978, in H. Zollinger, “Color Chemistry”, VCH 1991, in R. M. Christie, “Colour Chemistry”, Royal Society of Chemistry, 2001, and in references cited therein.

Such dyes and pigments are commercially available and can be directly incorporated in the polymer utilized to form the light absorption layer. For example, a polymer melt can be formed and the dye or pigment added thereto, combined by mixing, blending, and the like, and the resulting polymer/dye or pigment combination may then be utilized to form a light absorption layer. In other embodiments, the dye or pigment may be combined with a polymer utilized to form the light absorption layer as a color concentrate wherein the dye or pigment is in a compatible polymer, solution or dispersion. A polymer melt can be formed, a color concentrate may be added thereto, combined by mixing, blending, and the like, and the resulting polymer/dye or pigment combination may then be utilized to form a light absorption layer.

Absorption layers may possess one or more types of polymeric matrices in one or more absorption layers, and the degree and type of absorption in the absorption layers may be controlled by the composition, thickness and method of processing of the resins utilized to form these absorption layers.

In embodiments, the absorption layer may have a thickness from about 0.1 mm to about 2 mm, in embodiments from about 0.2 mm to about 1.5 mm.

The amount of colorant in an absorption layer may vary from about 0.0005% to about 1.8% by weight, and in embodiments from about 0.003% to about 0.5% by weight.

A display screen of the present disclosure will generally be positioned with the absorption layer closer to an individual viewing the display screen and the diffusion layer closer to the projector. The absorption layer permits one to fashion a display screen which can reduce the brightness (and thereby increase the contrast) over a very wide range of wavelengths, in embodiments the complete visible spectrum.

The display contrast ratio of a screen is the brightness of a white image versus the brightness of a black image. The brightness of a black image is mainly contributed by the ambient light. Ambient light usually comes from the viewer side of a display screen because most projection systems are inside a cabinet which blocks ambient light from the projection side of the screen. There are thus several optical paths by which ambient light may be reflected back to a viewer: (a) reflected by the back surface of the diffusion layer; (b) scattered by the scattering particles in the diffusion layer and reflected to the viewer; (c) reflected by the front surface of the diffuser (only a very small portion); (d) reflected from the front surface of the absorption layer, especially where the absorption layer is the outside layer of the screen; and (e) reflected from the outside layer of the display screen when such layer is, for example, a protective layer, an abrasion resistant layer, an antistatic layer or other such layer as described below, but not necessarily where the outside layer is, for example, an anti-glare layer, anti-reflection layer or embossed surface designed to prevent such reflection. Such outer layers may be applied to the outside of the absorption layer.

For display screens of the present disclosure, while the absorption layer will absorb projected light, projected light goes through the absorption layer only once. To the contrary, ambient light will travel twice through the absorption layer and thus experience much more loss in the absorption layer than projected light. As there is much greater absorption of ambient light, the contrast ratio is greatly improved.

A display screen of the present disclosure, possessing both a diffusion layer and an absorption layer, may have a thickness from about 0.6 mm to about 5 mm, in embodiments from about 0.8 mm to about 4 mm. Where additional layers are present, such as a clear support layer, the thickness of a display screen of the present disclosure may increase and be from about 1.5 mm to about 10 mm, in embodiments from about 2.0 mm to about 8 mm.

The degree and type of scattering in the diffusion layer(s) may be controlled by the composition and processing of the polymeric materials used. Similarly, the magnitude and frequency characteristics of the light absorption by the absorption layer(s) may be controlled by the compositions and processing methods used.

Display screens of the present disclosure possessing the above diffusion layer(s) and absorption layer(s) may be produced by lamination, co-extrusion, molding, injection molding, coinjection molding, (co)molding, welding, in situ polymerization such as by ultra-violet or other radiation curing or heat curing techniques, or other suitable fabrication methods which provide a multilayer structure. The shape of the initially-produced multilayer structure can be subsequently modified and constrained by standard forming methods such as thermoforming and/or by mounting it into a frame which holds it in a particular shape.

In embodiments, the display screen of the present disclosure may be formed by co-extrusion of the diffusion layer(s), the absorption layer(s), and any optional layers such as described below. Where co-extrusion is utilized to form a display screen, the general method for forming the screen includes the following steps. A thermoplastic resin may be compounded with scattering particles to form a diffusion layer precursor material. The scattering particles may be incorporated in the polymeric matrix utilizing any method within the purview of those skilled in the art, including blending, mixing, and the like, to aid in the incorporation of the scattering particles in the polymeric matrix. Suitable methods include melt-compounding with an extruder such as a twin-screw extruder. The equipment and processing conditions required will depend on the nature of the matrix and diffuser particle materials and will be ascertainable by those skilled in the art.

Similarly, a thermoplastic resin may be compounded with a colorant to form an absorption layer precursor material. The colorant may be incorporated in the polymeric matrix utilizing any method within the purview of those skilled in the art, including blending, mixing, and the like, to aid in the incorporation of the colorant in the polymeric matrix. Suitable methods include melt-compounding with an extruder such as a twin-screw extruder. The equipment and processing conditions required will depend on the nature of the matrix and colorant materials and will be ascertainable by those skilled in the art.

Once the diffusion layer precursor and the absorption layer precursor have been formed, the two may be co-extruded to form a display screen comprising a diffusion layer and an absorption layer. In embodiments, the diffusion layer precursor and the absorption layer precursor may be heated to enhance formation of the display screen. The diffusion layer precursor and the absorption layer precursor may be heated to a temperature of from about 205° C. to about 260° C, in embodiments from about 210° C. to about 250° C.

Equipment for this co-extrusion operation is commercially available and methods for conducting such a co-extrusion operation are within the purview of one skilled in the art. Such co-extrusion can, for example, be performed on a coextrusion sheet line in which two or three extruders feed the different layer materials into a co-extrusion sheet die, such as a feed block or coathanger-type die. This sheet die then extrudes the sheet onto a three-roll stack or other suitable take-off mechanism to continuously produce a flat multilayer sheet without bending, warping or other distortions. This continuous sheet can then be cut into pieces of the desired size to produce a display screen of the present disclosure. If it desired that the final display screen product possesses a curvature, this can be mechanically imparted to the separate cut sheet pieces after takeoff, or the multilayer sheet composition and/or manufacturing process can be designed to impart such desired curvature.

In embodiments, the diffusion layer and the absorption layer are coextensive; that is, the area of the diffusion layer is equal to the area of the absorption layer. For example, the co-extrusion process described above may be utilized to produce a display screen having a diffusion layer which is coextensive with the absorption layer. Display screens possessing such layers may have varying areas. Where utilized with a rear projection system, the area of a display screen may be from about 0.5 square feet (0.04 square meter) to about 500 square feet (50 square meters), depending on the specific application.

Display screens may also optionally possess one or more interfacial layers, adhesive layers, supporting layers, protective layers to protect the display screen from physical damage such as scratching or gouging, matte layers, anti-reflection layers, anti-glare layers, antistatic layers, light focusing or light angle modification layers, and/or embossed surface layers to enhance optical or other properties of the device.

A projection system of the present disclosure may also include one or more layers to focus the light rays or alter their angular direction before the light impinges on the diffuser layer, such as Fresnel, lenticular or other prism structures. In addition, the construction may also include one or more supporting layers to provide improved physical strength, stiffness, resistance to mechanical distortion, temperature resistance or other properties in the optical device. These supporting materials and thicknesses and the matrix materials and thicknesses used for the diffusion and tint layers are selected in combination to provide the requisite physical properties, for example high modulus to provide rigidity for large screens, and in embodiments such screens may vary in size from about 0.5 square feet (0.04 square meter) to about 500 square feet (50 square meters) depending on the specific application.

In embodiments, a display screen of the present disclosure may possess an interfacial layer between the diffusion layer and the absorption layer. Such an interfacial layer can include a separate adhesive layer or a transition zone between the aforesaid two layers resulting from the manufacture of the multilayer system by lamination, coextrusion, welding or other methods of construction.

Another embodiment of the present disclosure is a display screen for the visualization of projected light images by transmission which includes at least one diffusion layer and at least one absorption layer, and optionally one or more interfacial layers, adhesive layers, protective layers, anti-glare layers, anti-reflection layers, antistatic layers, light focusing or light angle modification layers, and supporting layers.

In the transmission mode, the light may enter from the diffusion layer side and may be scattered forward to provide a combination of transmission gain (or brightness), resolution and scattering half angle, i.e., the angle from the normal angle to the surface at which the transmission is half that at the normal angle, which is controlled by the composition and processing methods used to make the diffusion layer and the diffusion layer thickness. The light then passes through into the absorption layer where the frequency characteristics of the light can be modified and the brightness of the image and the contrast controlled by selection of the types and amounts of the dyes or pigments incorporated in the absorption layer. The resulting desired image may then be viewed from the absorption layer side.

The present disclosure also provides display screens having substantially no grain, showing little or no scintillation, and substantially no hot spots or areas of excessive brilliance while diffusing the transmitted light over a wide area.

Another embodiment of the present disclosure is a multilayer optical device for the visualization of projected light images by reflection which comprises a reflection layer, at least one diffusion layer, at least one absorption layer, and optionally one or more interfacial layers, adhesive layers, protective layers, anti-glare layers, anti-reflection layers, antistatic layers, light focusing or light angle modification layers, and supporting layers.

Where a display screen of the present disclosure is to be utilized in reflection, the display screen may have one or more diffusion layers, one or more absorption layers, and a reflection layer. For operation in the reflection mode, the device may also incorporate one or more reflective layers which may include metallized layer(s) or other reflective material(s), for example a metallized mirror type film coated with a reflective material, such as silver, by sputtering or other suitable processes.

In the reflection mode, the light may enter from the absorption layer side and then pass into the diffusion layer where it is reflected from a reflection layer placed immediately behind the diffusion layer or separated from it by a thin clear or absorbing layer which provides a flat surface for attachment of the reflection layer. The light is then reflected back through the diffusion layer, where it undergoes more scattering and then again through the absorption layer where it undergoes a final modification of color or contrast properties to provide the final desired image.

Another embodiment of the present disclosure is a dual-mode multilayer optical device for the visualization of projected light images by both transmission and reflection which comprises a reflection layer, at least one diffusion layer, at least one absorption layer, and optionally one or more interfacial layers, adhesive layers, protective layers, anti-glare layers, anti-reflection layers, antistatic layers, light focusing or light angle modification layers, and supporting layers. The reflection layer is placed immediately behind the diffusion layer or is separated from it by a thin clear substrate which provides a flat surface for attachment of the reflection layer. The clear substrate may be made of any suitable material within the purview of those skilled in the art including, but not limited to, polymethyl methacrylates, polycarbonates, polystyrenes, methacrylate styrene copolymers, and the like. The reflective layer is selected to allow partial reflection and partial transmission, for example where reflection is in the range of 20-80% and transmission is in the range of 80-20%. Such reflective layers include, for example, metallized mirror type films described above, as well as Mylar. In use, the image will appear on both the front and rear surfaces of the screen using a single projector and can be viewed from both sides of the screen to produce an extremely broad viewing area.

The display screens of the present disclosure are based on a bulk light diffusion mechanism, which is quite different from the surface diffusion mechanisms obtained with surface coatings, rough surface or microbeaded surface treatments found on currently utilized large display screens for projector applications. Display screens of the present disclosure, possessing scattering particles in a diffusion layer and dyes or pigments in an absorption layer, have several advantages over screens formed by lamination or coating of scattering particles, absorption particles (i.e., colorant), or both.

For example, problems associated with screens formed by lamination include, but are not limited to, delamination; the entrapment of air between layers; size limitations, especially for large simulator screens, control room screens, outdoor displays, and the like; and problems with structural stability, especially for such large format screens.

Problems associated with coated screens include, but are not limited to, coating delamination; the fact that the coating can easily be scratched; the fact that coated screens attach dust, and cleaning the screens is difficult and can damage the screens; the fact that bending and forming screens is a problem since surface coatings can crack; the size limitations encountered with coated screens; and scintillation problems.

As display screens of the present disclosure may be formed by coextrusion, the above problems are avoided. Furthermore, coextrusion gives the same optics as perfect lamination, but the advantage of co-extrusion is that it imparts better mechanical properties to the resulting display screen.

Moreover, the present disclosure allows the contrast of a display screen to be increased without destroying the resolution, while still allowing wide viewing angles and good brightness. To the contrary, if both the colorant and scattering particles are incorporated in a single layer, obtaining the desired gain (brightness) and viewing angle leads to a marked deterioration in the resolution and the contrast. Separate absorption and diffusion layers are thus markedly and advantageously better than a single layer with both the scattering particles and the colorant incorporated therein.

In embodiments, a display screen of the present disclosure may be utilized in rear projection television systems, rear projection display screen systems for simulation rooms, control rooms, large advertising displays and information displays, and the like.

In embodiments, a rear projection system utilizing a display screen of the present disclosure may include various components, including a projector/projection engine which projects the image to be viewed. Examples of suitable projectors are known and within the purview of those skilled in the art and include, for example, the INFOCUS® LP120 projector from Infocus Corporation, and the Mitsubishi HC3000 home theater projector from Mitsubishi.

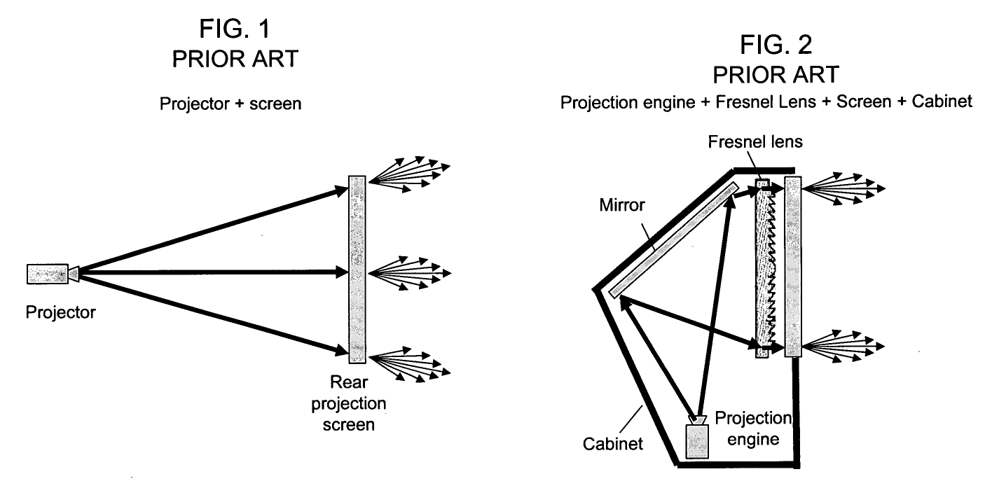

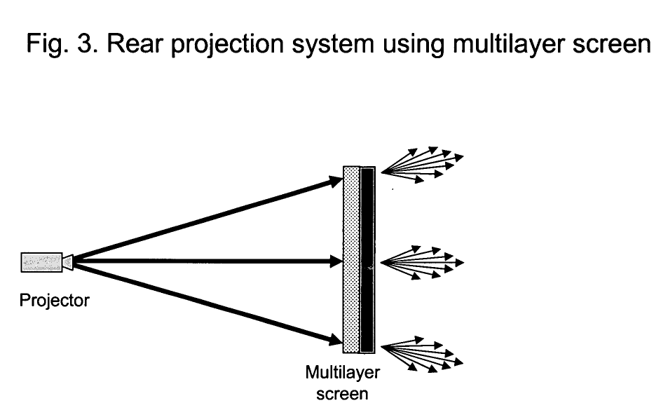

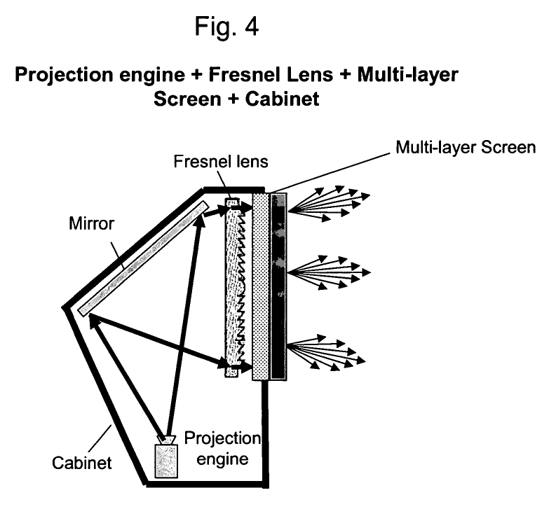

A general depiction of a rear projection system as known in the prior art is set forth in FIG. 1; a depiction of a rear projection system utilizing a multilayer display screen of the present disclosure is set forth in FIG. 3; a depiction of a prior art rear projection television system is set forth in FIG. 2; and a depiction of a rear projection television system utilizing a multilayer display screen of the present disclosure is provided as FIG. 4. As depicted in FIG. 4, the components of the projection television system may be housed in a cabinet with the multi-layer screen of the present disclosure forming the display screen on which images are viewed.

In embodiments, a rear projection television system may also include a mirror or mirror system to reflect projected images and reduce the depth of the projection system. Such mirrors are within the purview of those skilled in the art and include, for example, commercially available mirrors such as JDSU HR96 front surface mirrors from JDSU.

Rear projection television systems may also include a fresnel lens, which may include a thin optical lens having concentric rings of segmental lenses and having a focal length to collimate projected light. Such lenses are within the purview of those skilled in the art and include, for example, commercially available lenses such as Fresnel Technologies' #48.4 fresnel lens from Fresnel Technologies and DNP fresnel lenses from DNP, Inc. Fresnel lenses may be fabricated utilizing methods within the purview of those skilled in the art, including compression molding, injection molding, and the like. Fresnel lenses may be made of polymeric materials, including but not limited to methacrylate polymers, styrene/methacrylate copolymers, polyethylene terephthalate and polycarbonates. In some embodiments, fresnel lenses may also be formed by UV curing of UV curable monomers such as di-, tri- and multi-functional monomers such as di- and tri-functional acrylic or methacrylic monomers with methacrylates, methacrylate/styrene copolymers, epoxides and polycarbonates.

A rear projection television system may also include a lenticular lens which, in embodiments, may be attached to a display screen of the present disclosure on the side of the screen closer to the projector. Such lenticular lenses are within the purview of those skilled in the art and include, for example, a Toppan FC screen from Toppan Printing Co., Ltd. Lenticular lenses may be made of various materials including, but not limited to, methacrylates, methacrylate/styrene copolymers, polycarbonates, polyethylene terephthalate, and UV curing materials as described above for use in forming fresnel lenses.

The above components of a projection television system may be housed in a cabinet; the display screen of the present disclosure forms the screen of the television on which images are viewed. The absorption layer of the display screen will be adjacent to an individual viewing the television, while the diffusion layer of the display screen will be adjacent to the interior of the cabinet, adjacent to the fresnel lens and/or lenticular lens, if present.

The following Examples are being submitted to illustrate embodiments of the present disclosure. These Examples are intended to be illustrative only and are not intended to limit the scope of the present disclosure.

### EXAMPLE 1

A translucent thermoplastic composition containing a scattering species was extruded to produce a film or sheet which scatters polychromatic light at small angles and which acts as a diffusion layer in the present invention. This diffusion layer included a mixture of a polymeric matrix, Atoglas V-826 (Arkema), which is a methyl methacrylate polymer containing a small amount of copolymerized alkyl acrylate and having a melt flow rate of about 1.6 g/10 min as measured under Condition 1 of ASTM D-1238, and core-shell diffuser particles (Paraloid EXL 5136; Rohm and Haas). The core-shell diffuser particles were spherical core-shell particles, with an average diameter ranging from about 2 microns to about 15 microns, possessing a core of an alkyl acrylate rubber including a copolymer of alkyl acrylate and styrenic monomers, and one or more outer shells, wherein the outermost shell was primarily a methyl methacrylate polymer which was compatible with the matrix methyl methacrylate polymer. These two components were dry blended and then compounded in a twin screw extruder to produce pellets using a strand die at a melt temperature of about 240° C. These pellets were then dried and extruded at a melt temperature of about 230° C. through an approximately 66-inch wide flat sheet die to produce the scattering film of the present invention.

Compositions of varying ratios by weight of the diffuser particles and the polymeric matrix, from 2/98 to 40/70, were prepared and the optical properties determined. The optical properties of the resultant film or sheet were determined by several different methods including light scattering in transmission and reflection modes using Yokogawa or Minolta light meters and an Olympus microscope. Refractive indices were determined with an Abbe refractometer. Optical properties measured included peak gain, viewing angle, resolution, surface reflection and diffuse transmission.

Some peak gain and half-angle data are shown for films of varying thicknesses and diffuser concentration in Table 1 below.

TABLE 1

| Diffuser Layer | Diffuser | Peak | |
|---|---|---|---|
| Thickness mm | Conc., wt. % | Gain | Half-Angle° |
| 0.82 | 10 | 9.6 | 12.8 |
| 0.82 | 15 | 8.3 | 14.0 |
| 0.86 | 15 | 4.2 | 21.9 |
| 1.03 | 15 | 3.1 | 25.2 |
| 1.75 | 15 | 1.9 | 34.5 |
| 2.78 | 15 | 1.1 | 45.5 |
| 0.82 | 20 | 4.2 | 20.5 |
| 0.88 | 20 | 3.1 | 26.1 |
| 0.95 | 20 | 2.7 | 27.7 |
| 1.83 | 20 | 1.4 | 43.0 |
| 2.75 | 20 | 0.9 | 53.0 |
| 0.82 | 30 | 2.6 | 27.0 |
| 0.88 | 30 | 2.2 | 31.5 |
| 1.75 | 30 | 1.1 | 50.0 |
| 2.65 | 30 | 0.7 | 62.0 |

### EXAMPLE 2

A thermoplastic based absorption layer containing a light absorber was also extruded to produce a film or sheet which absorbed polychromatic light and acted as an absorption layer. This absorber film included a polymeric matrix, Atoglas DR-101 (Arkema), which is an impact-modified methyl methacrylate polymer containing a small amount of copolymerized alkyl acrylate and has a melt flow rate of about 1 g/10 min measured under Condition 1 of ASTM D-1238, and a polymer-soluble black anthraquinone dye (LambdaPlast Solvent Black LN) was added as a light absorber in concentrations ranging from 0.07% to 0.003%. These components were dry blended and then compounded in a twin screw extruder to produce pellets using a strand die at a melt temperature of about 240° C. These pellets were then dried and extruded at a melt temperature of about 230° C. through an approximately 66-inch wide flat sheet die to produce the absorption layer of the present disclosure. The optical properties of the resultant film or sheet were determined as in Example 1.

A typical example of this absorption layer sheet, which included a LambdaPlast Solvent Black LN concentration of 0.02% by weight and 99.98% Atoglas DR-101 methyl methacrylate matrix polymer, and had a thickness of 0.67 mm, showed a total visible light transmission of 49.9%.

### EXAMPLE 3

The compounded materials produced in Examples 1 and 2 were co-extruded as a bilayer sheet to produce a display screen of the present disclosure possessing a diffusion layer to scatter polychromatic light and an absorption layer to absorb light and provide contrast. Different layers with varying thicknesses and weight % of diffuser particles were prepared. The optical properties of the resultant display screens were determined as in Example 1. The various display screen and their properties are shown in Table 2 below.

TABLE 2

| | | | | Diffuser | | |
|---|---|---|---|---|---|---|
| | Tint | Tint Layer | Diffuser | Layer | | |
| Display | Conc., | Thickness | Conc., | Thickness | Peak | |
| Screen | wt. % | mm | wt. % | mm | Gain | Half Angle° |
| 1 | 0.02 | 0.90 | 15 | 0.94 | 2.2 | 19 |
| 2 | 0.02 | 0.94 | 15 | 1.02 | 1.9 | 21 |
| 3 | 0.02 | 0.81 | 15 | 1.02 | 2.1 | 21 |
| 4 | 0.02 | 1.65 | 15 | 1.14 | 1.0 | 22 |
| 5 | 0.02 | 1.27 | 15 | 1.14 | 1.4 | 22 |
| 6 | 0.02 | 1.14 | 15 | 1.14 | 1.5 | 22 |
| 7 | 0.02 | 1.02 | 15 | 1.14 | 1.6 | 22 |
| 8 | 0.02 | 0.94 | 15 | 1.14 | 1.8 | 22 |
| 9 | 0.02 | 0.89 | 15 | 1.14 | 1.9 | 22 |
| 10 | 0.02 | 0.81 | 15 | 1.14 | 2.0 | 22 |
| 11 | 0.02 | 0.89 | 20 | 0.90 | 1.5 | 22 |
| 12 | 0.02 | 0.81 | 20 | 0.90 | 1.7 | 22 |

The resolution of display screen 1 from Table 2 above was about 5 lines/mm; the surface reflection under room ambient light was about 1.8 cd·mm2. Similarly advantageous results were found for the other structures shown in Table 2.

### COMPARATIVE EXAMPLE 1

A monolayer system was made as described in Example 1, but the soluble black dye of Example 2 was incorporated into the diffusion layer instead of forming a separate absorption layer. This monolayer composition was adjusted to give the same peak gain (2.2) and half angle (19°) as the bilayer display screen structure described as display screen 1 of Table 2 above and had a thickness of about 1.84 mm. The V-826 polymethyl methacrylate polymer matrix contained about 7.5% of the diffuser particles (Paraloid EXL-51 36) and about 0.01% of the soluble black dye of Example 2. Although the peak gain and half-angle properties were matched with the bilayer system of Example 3, the overall optical properties of the monolayer system were far less advantageous since the resolution was now only 3.5 lines/mm (instead of 5 lines/mm) and the surface reflection under room ambient light was 2.6 cd·mm2 (instead of 1.8 cd·mm2) evidencing a much poorer contrast ratio.

### EXAMPLE 4

The two layers of Examples 1 and 2 were bonded together by a lamination process and the optical properties of the resultant structures determined as in Example 1. The resulting display screens possessed optical properties that were essentially the same as those of the display screens of Example 3.

### EXAMPLE 5

The two layers of Examples 1 and 2 were bonded together by a solvent welding process and the optical properties of the resultant structures determined as in Example 1. The resulting display screens possessed optical properties that were essentially the same as those of the display screens of Example 3.

### EXAMPLE 6

Example 3 was repeated, but in this Example a three layer display screen was constructed having an absorption layer of Example 2, a diffusion layer of Example 1, and a clear support layer constructed with the polymeric matrix of Example 2 (Atoglas DR-101 (Arkema)), without the addition of any colorant. The diffusion layer was positioned between the absorption layer and the support layer. The optical properties of the resulting structure were then determined by the methods described in Example 1. The optical results for some typical structures are shown in Table 3.

TABLE 3

| | | | Diffuser | | | |
|---|---|---|---|---|---|---|
| Tint | Tint Layer | Diffuser | Layer | Support | | |
| Conc., | Thickness | Conc., | Thickness | Thickness | Peak | Half |
| wt. % | mm | wt. % | mm | mm | Gain | Angle° |
| 0.07 | 0.25 | 20 | 2.15 | 2.60 | 0.8 | 40 |
| 0.04 | 0.25 | 20 | 1.12 | 3.63 | 2.4 | 28 |

### EXAMPLE 7

Example 4 was repeated using a channel carbon black pigment from Cabot Corporation as the absorbing species. At comparable contrast ratios, significantly lower brightness and peak gain values were obtained with the insoluble channel black pigment compared with the soluble black dye used in Example 4.

### EXAMPLE 8

Example 3 was repeated, except in this Example both the diffusion layer and the absorption layer were constructed using Lexan 123 polycarbonate (General Electric Plastics) as the polymeric matrix instead of polymethyl methacrylate. The diffusion layer utilized the Paraloid EXL-5136 diffuser particles of Example 1 and the absorption layer utilized the soluble dye of Example 2. Optical properties of the resulting display screen were measured as described in Example 1. The absorption layer had a thickness of about 0.9 mm; and the diffusion layer had a thickness of about 1 mm. Advantageous and unusual combinations of gain and half-angle characteristics were noted and typical values are shown in Table 4.

TABLE 4

| Tint Conc., | Diffuser Conc., | | |
|---|---|---|---|
| wt. % | wt. % | Peak Gain | Half Angle° |
| 0.02 | 1.0 | 1.2 | 25 |

### EXAMPLE 9

Example 3 was again repeated, but in this Example the diffuser particles in the diffusion layer were NYASIL™ 6200 silica particles (from Nyacol Nano Technologies, Inc., Ashland, Mass.) having a mean particle diameter of about 1.7 microns. The absorption layer had a thickness of about 1 mm, and the diffusion layer had a thickness of about 2 mm. Optical properties were measured as described in Example 1. Advantageous and unusual combinations of gain and half-angle characteristics were again noted and typical values are shown in Table 5.

TABLE 5

| Tint | Diffuser Conc., | | |
|---|---|---|---|
| Conc. wt. % | wt. % | Peak Gain | Half Angle° |
| 0.01 | 10 | 2.7 | 15 |

### EXAMPLE 10

An absorption layer was constructed as described above in Example 2, except the polymeric matrix was a copolymer resin of about 60% methyl methacrylate and about 40% styrene (MS resin TX-400 S Natural, from Denki Kagaku K. K.). The soluble dye was added thereto as described above in Example 2. A diffusion layer was produced as described above in Example 1, except the same MS resin TX-400 S Natural described above for use in the absorption layer was also utilized as the polymeric matrix in combination with the particles (Paraloid EXL-5136) of Example 1. The two layers were bonded by a lamination process. The absorption layer had a thickness of about 0.9 mm; the diffusion layer had a thickness of about 1 mm. Optical properties of the resultant structure were determined as in Example 1. The results are shown in Table 6 below.

TABLE 6

| Tint | Diffuser Conc., | | |
|---|---|---|---|
| Conc., wt. % | wt. % | Peak Gain | Half Angle° |
| 0.020 | 2.5 | 2.1 | 20 |

### EXAMPLE 11

A dual-mode front-and-rear projection screen was constructed similar to Example 3 but also incorporating a metallized film with a mirrored reflecting surface positioned on the outside of the diffuser layer side of the diffuser layer-absorption layer structure. This metallized film allowed 40% of the light incident on it to be transmitted and 60% to be reflected. This screen structure showed a peak gain of 1.2 when viewed from the front absorption layer side and 2.3 when viewed from the rear mirrored side, and a viewing gain half angle of 25°.

It will be appreciated that a variety of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A device comprising:
at least one diffusion layer comprising a thermoplastic resin in combination with scattering particles, the diffusion layer having a thickness from about 0.45 mm to about 4 mm; and
at least one absorption layer comprising a thermoplastic resin in combination with at least one colorant, the absorption layer having a thickness from about 0.1 mm to about 2 mm,
wherein the diffusion layer is coextensive with the absorption layer.

2. A device according to claim 1 wherein the thermoplastic matrix for the diffusion layer and optionally the absorption layer has a refractive index of from about 1.45 to about 1.66 and is selected from the group consisting of polyalkyl acrylates, polyalkyl methacrylate polymers, aralkyl methacrylate polymers, methacrylate copolymers, polyalkylstyrenes, styrenic polymers and copolymers, cyclic polyolefins, polyolefins, polyetherimides, polyetherimide sulfones, polysulfones, polyethersulfones, polyphenylene ether sulfones, poly(arylene ether)s, polycarbonates, polyester carbonates and combinations thereof.

3. A device according to claim 1 wherein the thermoplastic matrix for the diffusion layer and optionally the absorption layer has a refractive index of from about 1.49 to about 1.59 and is selected from the group consisting of polymethyl methacrylate, polystyrene, styrene-acrylonitrile copolymers, polystyrene methacrylate copolymers, styrene-methyl methacrylate copolymers, olefin-vinyl acetate copolymers, polymethylpentene, polyethylene, polypropylene, copolymers of polyethylene and polypropylene, polyglutarimide, and combinations thereof.

4. A device according to claim 1, wherein the scattering particles are selected from the group consisting of immiscible glass particles, immiscible mineral particles, and immiscible ceramic particles.

5. A device according to claim 1, wherein the scattering particles are selected from the group consisting of alkyl (meth)acrylate-type resins, styrene-type resins, vinyl carboxylate resins, polysiloxane-type resins, and homopolymers, copolymers and combinations thereof.

6. A device according to claim 1, wherein the scattering particles have a core-shell configuration.

7. A device according to claim 1, wherein the scattering particles have a diameter of from about 0.4 microns to about 20 microns and are present in the diffusion layer in an amount from about 2% to about 40% by volume.

8. A device according to claim 1, wherein the scattering particles have a diameter of from about 2.5 microns to about 12.5 microns and are present in the diffusion layer in an amount from about 8% to about 30% by volume.

9. A device according to claim 1, wherein the colorant is selected from the group consisting of dyes and pigments.

10. A device according to claim 9, wherein the colorant is soluble in the polymeric matrix utilized to form the absorption layer and is selected from the group consisting of black anthraquinone dyes, black azine dyes, black azo dyes, and sulfur black dyes.

11. A device according to claim 9, wherein the colorant is insoluble in the polymeric matrix utilized to form the absorption layer and is selected from the group consisting of carbon black, black iron oxide, copper chromite, titanium black, and insoluble organic pigments,

12. A device according to claim 9, wherein the colorant is present in the absorption layer in an amount from about 0.0005% to about 1.8% by weight.

13. A device according to claim 9, wherein the colorant is present in the absorption layer in an amount from about 0.003% to about 0.5% by weight.

14. A device according to claim 1, further comprising at least one additional layer selected from the group consisting of interfacial layers, adhesive layers, supporting layers, protective layers, matte layers, anti-reflection layers, anti-glare layers, antistatic layers, light focusing layers, light angle modification layers, embossed surface layers, and combinations thereof.

15. A rear projection system comprising the device of claim 1, wherein the rear projection system is selected from the group consisting of rear projection television systems, rear projection display screen systems for simulation rooms, rear projection display screen systems for control rooms, large advertising displays, information displays, and the like.

16. A rear projection television system comprising:
a projector;
a mirror;
a fresnel lens;
a lenticular lens; and
the device of claim 1,
wherein the components of the projection television system are housed in a cabinet with the device of claim 1 forming the display screen on which images are viewed.

17. A device comprising:
at least one diffusion layer comprising a methyl methacrylate copolymer in combination with core-shell scattering particles comprising an average diameter from about 2 microns to 15 microns, the diffusion layer having a thickness from about 0.45 mm to about 4 mm; and
at least one absorption layer comprising a methyl methacrylate copolymer in combination with a polymer soluble black anthraquinone dye, the absorption layer having a thickness from about 0.1 mm to about 2 mm,
wherein the diffusion layer is coextensive with the absorption layer.

18. A method for forming a display screen comprising:
contacting a thermoplastic resin with scattering particles to form a diffusion layer precursor;
contacting a thermoplastic resin with a colorant to form an absorption layer precursor; and
co-extruding the diffusion layer precursor and the absorption layer precursor to form a display screen comprising a diffusion layer and an absorption layer,
wherein the diffusion layer has a thickness from about 0.45 mm to about 4 mm, the absorption layer has a thickness from about 0.1 mm to about 2 mm, and the diffusion layer is coextensive with the absorption layer.

19. The method of claim 18, wherein the diffusion layer precursor and the absorption layer precursor are heated to a temperature of from about 205° C. to about 260° C.

20. The method of claim 18, wherein the thermoplastic matrix for the diffusion layer precursor and optionally the absorption layer precursor has a refractive index of from about 1.45 to about 1.66 and is selected from the group consisting of alkyl acrylates, polyalkyl methacrylate polymers, aralkyl methacrylate polymers, methacrylate copolymers, styrenic polymers, polyalkylstyrenes, styrenic copolymers, cyclic polyolefins, polyolefins, polyetherimides, polyetherimide sulfones, polysulfones, polyethersulfones, polyphenylene ether sulfones, poly(arylene ether)s, polycarbonates, polyester carbonates and combinations thereof.

21. The method according to claim 18, wherein the scattering particles are selected from the group consisting of immiscible glass particles, immiscible mineral particles, immiscible ceramic particles, alkyl (meth)acrylate-type resins, styrene-type resins, vinyl carboxylate resins, polysiloxane-type resins, and homopolymers, copolymers and combinations thereof, the scattering particles have a diameter of from about 0.5 microns to about 20 microns, and wherein the scattering particles are present in the diffusion layer in an amount from about 2% to about 40% by volume.

22. The method according to claim 18, wherein the colorant is selected from the group consisting of black anthraquinone dyes, black azine dyes, black azo dyes, sulfur black dyes, carbon black, black iron oxide, copper chromite and titanium black, and the colorant is present in the absorption layer in an amount from about 0.0005% to about 1.8% by weight.

23. A display screen comprising:
at least one diffusion layer comprising a thermoplastic resin in combination with scattering particles, the diffusion layer having a thickness from about 0.45 mm to about 4 mm;
an optional absorption layer comprising a thermoplastic resin in combination with at least one colorant, the absorption layer having a thickness from about 0.1 mm to about 2 mm; and
a reflective layer applied to the at least one diffusion layer;
wherein the diffusion layer is coextensive with the absorption layer and the reflective layer permits both partial reflection and partial transmission of light, thereby permitting images to be visualized by both reflection and transmission.

24. The display screen of claim 23, further comprising a thin clear substrate between the diffusion layer and the reflective layer.
